(19) United States
(12) Patent Application Publication
(10) Pub. No.: US 2005/0208344 A1
(43) Pub. Date: Sep. 22, 2005

(54) Power supply

(76) Inventor: William Tan, Los Angeles, CA (US)

Correspondence Address: PHILIP K. YU, 20955 PATHFINDER ROAD, SUITE 100, DIAMOND BAR, CA, 91765, US

(21) Appl. No.: 10/506,149

(22) PCT Filed: Feb. 27, 2002
(86) PCT No.: PCT/SG02/00031

§ 371 Date: Aug. 27, 2004

(51) Int. Cl. H01M 2/00; H01M 2/02; H01M 10/48; H01M 10/46

(52) U.S. Cl. 429/7; 429/176; 429/92

(57) ABSTRACT

A power supply 1 for an electronic device comprising electric cells 7 arranged to generate an intermediate voltage Vx, and a voltage converter 30 coupled to the electric cells 7, the voltage converter 30 converting the intermediate voltage Vx to an output voltage Vo, wherein the converter 30 comprises a switch 14 to vary the output voltage Vo to match an input voltage of the electronic device.

This invention relates to a power supply, more particularly but not exclusively, for an electronic device such as a laptop computer.

A common drawback for a laptop computer is its reliance on the power supplied by a battery in order to be mobile. Conventionally, the necessary power is provided using a battery pack accommodated in a battery bay of the laptop. However, battery technology has always lagged behind the development of better liquid-crystal displays, peripherals and faster processors which demand morel power. Despite the use of new power management technology to better manage the use of power, a typical unplug runtime for a fully-charged battery pack is still only about 2 to 4 hours, depending on the applications which run on the laptop computer.

Additional battery packs allow the user to extend the “runtime” of the laptop computer or otherwise there is a need to find an AC power source, thereby limiting the user's mobility. This also means purchasing extra battery packs from the laptop vendor. The battery packs are usually expensive and are specific to the brand and model of the laptop computer.

Hence, it is usual that a battery pack for one laptop computer will not fit another. This is also normally the case when upgrading to a newer model from the same manufacturer. Thus, the user will usually find that any additional battery packs purchased will become obsolete when the user upgrades to a new laptop computer.

Typically, the mobile user carries the extra battery packs with him in order to replace the exhausted battery pack with a charged pack. However, the size and weight of existing battery packs do not make transportation easy as they are normally thick and bulky which takes up precious storage space for the mobile user. Moreover, if the laptop computer has only one battery bay, there is a need to power down the notebook prior to performing the replacement. This is an added inconvenience. Another disadvantage is the need to recharge the exhausted battery pack in the battery bay of the laptop computer. The need for an AC power source for the recharging is also a further disadvantage which reduces a user's mobility.

According to a first aspect of the invention, there is provided a power supply comprising an electric cell arranged to generate an intermediate voltage, and voltage conversion means coupled to the electric cell, the voltage conversion means converting the intermediate voltage to an output voltage, wherein the conversion means comprises adjustment means to vary the output voltage.

In the context of this application, the term “electric cell” means a device for converting chemical energy into electrical energy.

An advantage of the invention is that the power supply is able to adapt or vary the output voltage to charge or power an electronic device. Therefore, the power supply is not limited to the make, model or the input voltage requirement of the electronic device.

Typically, the adjustment means comprises a manual switch which may be moved to vary the output voltage. Therefore, the switch may be moved to select the desired output voltage that corresponds to the input voltage required by the electronic device. The power supply may further comprise a lock mechanism to releasably lock the switch in the selected position to minimise the risk of the switch from being unintentionally adjusted.

In an alternative, the adjustment means comprises detection means to detect an input voltage of an electronic device coupled to the output voltage, in use and the adjustment means automatically adjusts the output voltage to correspond to the detected input voltage of the electronic device, without manual intervention. Therefore, when connected to the electronic device, the power supply auto-detects the required input voltage of the electronic device and automatically adjusts the conversion means to output the required output voltage to match the input voltage. Typically, the conversion means is a DC-DC voltage converter and the output voltage is a DC voltage.

Preferably the electric cell is rechargeable. For example, the electric cell may be a lithium-ion cell such as a lithium ion polymer or prismatic cell. Typically, the power supply may comprise a number of cells coupled together in a series or parallel connection or a combination of both to provide the intermediate voltage. The voltage conversion means may be activated by a switch to convert the intermediate voltage to the output voltage to power the electronic device.

Typically, the power supply further comprises charging means having an output coupled to the electric cell, the charging means being adapted to receive an input voltage and charging the electric cell in response to the received input voltage. When the electric cell is charged, the power supply may then be used to provide the necessary voltage to power the electronic device. The power supply may further comprise deactivation means to reduce discharging of the electric cell when not coupled to an electronic device.

Preferably, the charging means is adapted to receive a plurality of input voltages. An advantage of the charging means receiving a plurality of input voltages is that different AC power adapters can be used to provide the input voltage to the power supply. Specifically, an AC power adapter for the electronic device may be used to provide the necessary input voltage. This obviates the need to carry a separate AC power adapter to charge the power supply.

Typically, the charging means comprises means to monitor the charging or charge status of the electric cell. Preferably, the power supply further comprises a visual display device for displaying the charging or charge status of the electric cell. The visual display device may comprise a light emitting device or a graphic display and may be activated by a switch. This switch for activating the visual display device may be different or the same switch that is used to activate the voltage conversion means.

Preferably, the power supply further comprises a sound generation device which is activated when the electric cell is at a predetermined charge level.

Typically, the power supply further comprises a housing. Typically, the housing is relatively thin compared to the other dimensions of the housing, for example the length and width. This has the advantage of facilitating easier storage and/or portability of the power supply. Typically, the shape of the housing is rectangular. Alternatively, the housing may be any other suitable or desired shape.

Preferably, the electronic device is a portable electronic device, and typically a portable computing device, such as a laptop computer or a notebook computer.

An embodiment of the invention will now be described, by way of example, with reference to the accompanying drawings, in which:—

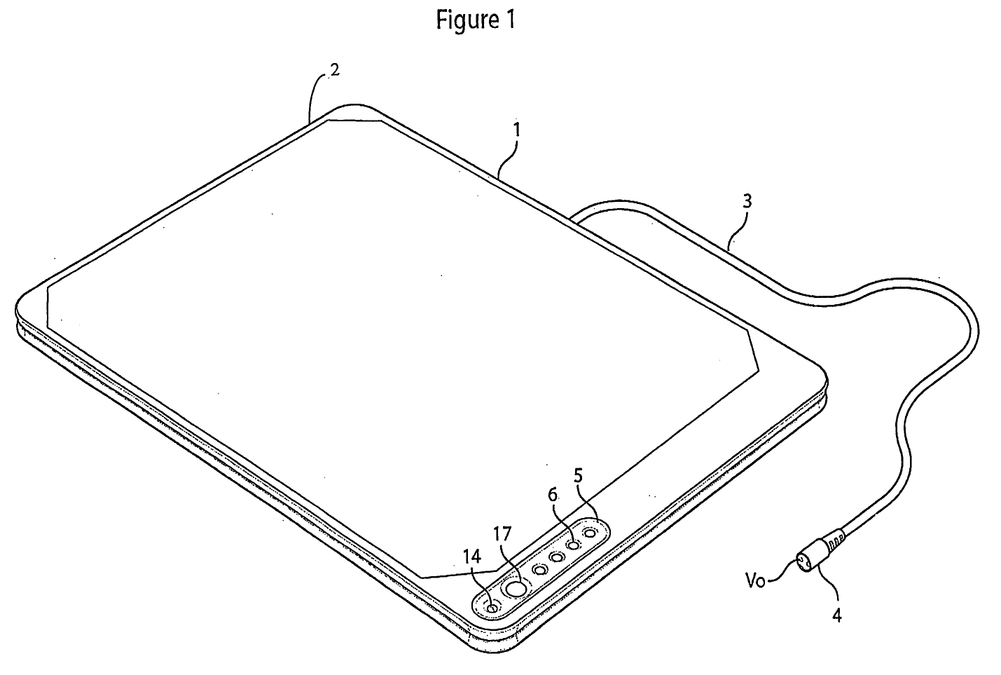

FIG. 1 is a perspective view of a power supply according to the invention;

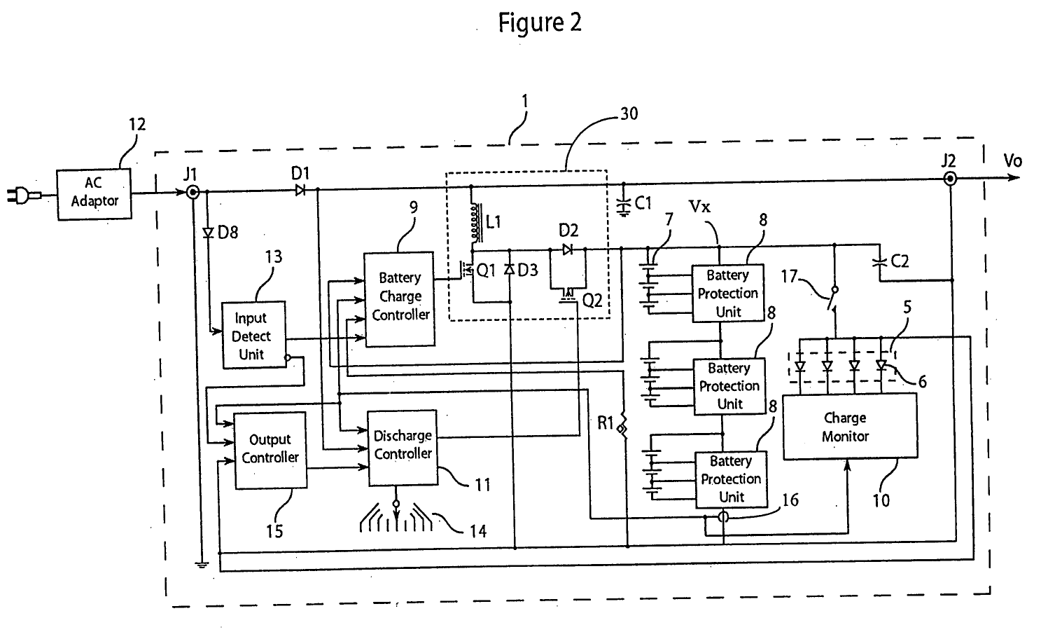

FIG. 2 is a circuit diagram of the power supply of FIG. 1; and

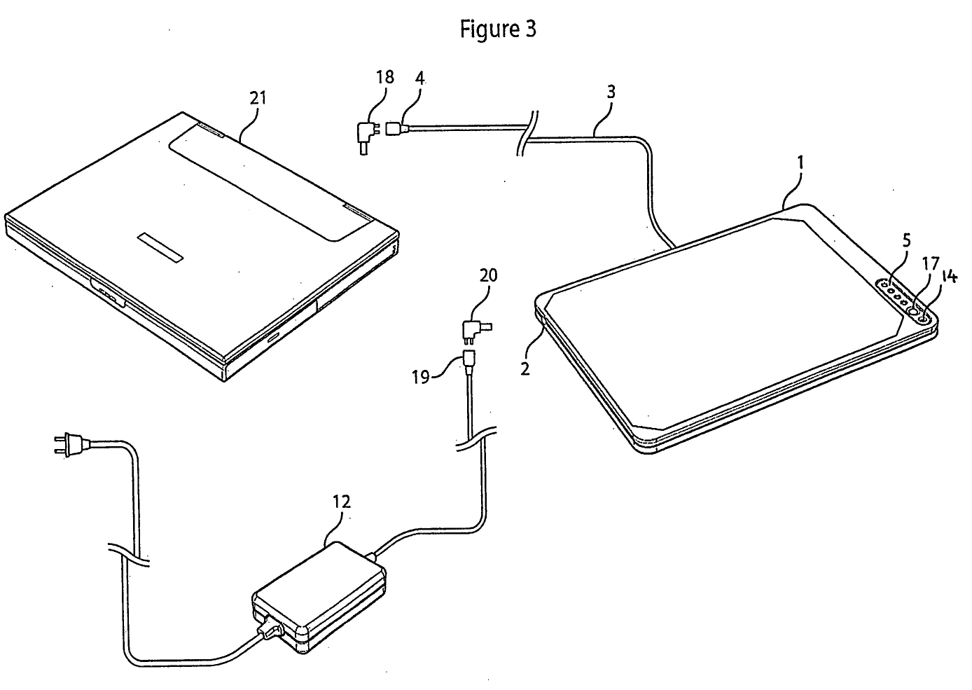

FIG. 3 depicts the power supply of FIG. 1 being used with an AC power adapter and a laptop computer.

FIG. 1 shows a perspective view of a power supply 1 comprising an input DC socket 2 (see FIG. 3), an output power cord 3 having an output plug 4, a multi-position adjustment switch 14, a test/start switch 17 and a charge indicator 5. Typically, the power supply 1 is rechargeable and thus the input DC socket 2 accepts an input voltage to charge or power the power supply 1 and the charge status is reflected on the charge indicator 5, which is activated by depressing the test/start switch 17. In this embodiment, the charge indicator 5 comprises four light emitting diodes (LEDs) 6 with each LED representing a particular level of charge. A fully charged power supply 1 will have all the LEDs 6 lit. In an alternative, more or fewer LEDs 6 may be used to represent the charging or discharging status.

Same colour LEDs 6 may be used for the charge indicator 5. In an alternative, different colour LEDs 6 may be used such that different colours are used to represent different levels of charge. In a further alternative, a graphic display or any suitable form of display may be used to represent the charging and discharging status. When charged, the power supply 1 generates an output voltage Vo to match an input voltage of a load, for example an electronic device, to which the power supply 1 is connected.

FIG. 2 shows the internal components of the power supply 1 which comprises electric cells 7, battery protection units 8, a battery charge controller 9, a discharge controller 11, a charge monitor 10 and a bi-directional voltage converter 30. The detailed operation of the power supply 1 will now be described.

An AC power adapter 12 converts AC power from a mains power source to DC, which enters the power supply 1 at node J1. The DC power is then used to charge electric cells 7, which provide an output voltage Vo exiting the power supply 1 at node J2 to power the electronic device. A diode D1 is connected between nodes J1 and J2 to minimise damage to the power supply 1 if a power source of wrong polarity is supplied to node J1.

The power supply 1 further comprises an input detection unit 13 to detect the absence of input DC power at node J1. An example of a commercial available input detection unit is a LP339 from National Semiconductor. The input detection unit 13 controls the battery charge controller 9 and the discharge controller 11, via an output controller 15. If there is no input DC power at node J1, the input detection unit 13 enables the discharge controller 11 via the output controller 15 to activate the voltage converter 30 to supply power from the cells 7. When this condition is detected, the detection unit 13 also disables the battery charge controller 9 at the same time since there is no power available to charge the cells 7. If DC power is present at node J1, then the discharge controller 11 is disabled and the battery charge controller 9 is enabled, by the input detection unit 13 for charging the cells 7. Therefore, this arrangement provides a safety mechanism which prevents the power supply 1 from being used to power the electronic device when the cells are being charged. This is to prevent the simultaneous charging and discharging of the cells 7 which may shorten the life of the cells 7.

As described earlier, an advantage of the power supply 1 is the ability to make use of the AC power adapter 12 of an electronic device to charge the cells 7. This means that the power supply 1 needs to accept a range of input DC voltages since different AC power adapters output different DC voltages. This is achieved by using the battery charge controller 9. The battery charge controller 9 accepts a range of DC voltages, depending on the model and type of controller 9, to charge the cells 7. The battery charge controller 9 monitors the cell voltage and the current charging the cells 7 to control the voltage converter 30. The battery charge controller 9 also monitors the temperature of the cells 7 by means of a thermistor R1, so that charging of the cells 7 is halted if the temperature of the cells 7 goes beyond a predetermined threshold or safe range. An example of a commercially available battery charge controller 9 is a BQ24700 integrated circuit from Texas instrument.

The battery charge controller 9 is connected to the bi-directional voltage converter 30 which comprises an inductor L1, two power MOSFETs (Q1, Q2), and two rectifier diodes (D2, D3). When charging the electric cells 7 using the AC power adapter 12, the inductor L1, power MOSFET Q1 and diode D2 form a “boost” converter to boost the input voltage up to a voltage required for charging the cells 7. A typical input range is between 12 and 24 volts and the boosted voltage will depend on the configuration and/or capacity of the electric cells 7. In this embodiment, the boosted voltage is typically between 27 and 37.8 volts (see below) to charge the electric cells 7.

The electric cells 7 may be an electrolytic cell such as a dry cell or a fuel cell. In this embodiment, nine rechargeable lithium-ion prismatic or polymer cells 7 are used, each generating a nominal voltage of 3.7 volts to supply a total nominal voltage of 33.3 volts. However, the actual voltage of a cell 7 may vary between a minimum voltage of 3 volts and a maximum voltage of 4.2 volts, depending on the type and make of the cells 7, thereby generating a total cell voltage ranging between 27 volts and 37.8 volts. An advantage of using lithium-ion prismatic or polymer cells 7 is the ability to achieve a slimmer form factor as compared to cylindrical lithium-ion cells or other conventional cells. Typically, lithium-ion prismatic or polymer cells 7 also have the advantage of exhibiting higher energy densities, thus enabling them to achieve additional runtime over other conventional cells for any given size. If desired, more cells 7 may be coupled in series or parallel or a combination of both to provide a higher output voltage Vo. In an alternative, a single high energy density cell may be used to provide the desired output voltage Vo.

In this embodiment, the electric cells 7 generate a nominal intermediate voltage Vx of 33.3 volts to the voltage converter 30 which converts the intermediate voltage Vx to the output voltage Vo of the power supply 1. As described earlier, the desired output voltage Vo is user selectable and the means to vary the output voltage Vo is via the adjustment switch 14. The adjustment switch 14 allows the user to select the desired output voltage Vo from a range of voltages by adjusting the position of the switch to match the required input DC voltage of the electronic device. The voltage converter 30, controlled by the discharge controller 11, then converts the intermediate voltage Vx to the desired output voltage Vo in accordance with the selected voltage. For example, if the electronic device requires an input DC voltage of 15 volts, the user adjusts the switch 14 to a position that corresponds to an output voltage Vo of 15 volts. This selection is received by the discharge controller 11 which in turn controls the converter 30 to convert the intermediate voltage Vx from 33.3 volts to an output voltage Vo of 15 volts to power the electronic device.

Therefore, during discharging, the voltage converter 30, formed by the inductor L1, MOSFET Q2 and diode D3, is performing as a “buck” converter to convert the intermediate cell voltage Vx to the output voltage Vo. The voltage Vo, preset by the adjustment switch 14, is typically between 12 and 24 volts. During discharging, the discharge controller 11 regulates and monitors the output voltage Vo in accordance with the desired output voltage Vo preset by the adjustment switch 14. The discharge controller 11 also monitors the cell current via a current monitor 16 arranged in series with the cells 7 to detect an overloading condition. An example of a discharge controller 11 which can be used is TL5001A from Texas Instrument.

Capacitors C1 and C2 are arranged to reduce the voltage ripple caused by pulsating currents. that are present at the input and output of the voltage converter 30.

In an alternative to the adjustment switch 14, an auto-detect circuitry may be used. When the electronic device is coupled to the power supply 1, the circuitry auto-detects the required DC input voltage of the connected electronic device and automatically converts the intermediate voltage Vx from the cells 7 to the required output voltage Vo. In this case, there is no need for user intervention and thus omits the need for the adjustment switch 14.

Battery protection units 8 protect the cells 7 from over-charging or over-discharging, and minimise damage to the cells 7 when a short-circuit occurs. When the cells 7 are fully charged, the battery protection units 8 cut off the charging current to the cells 7 to prevent over-charging. Conversely, when the cells 7 are drained to a predetermined charge level, the battery protection units 8 stop any further discharge of the cells 7. If an output of the cells 7 is shorted, the battery protection units 8 also stop any further charging or discharging of the cells 7. A typical off-the-shelf protection unit 8 is a Maxim MAX1665X battery pack protector which can perform the above tasks.

The output controller 15 receives inputs from the input detection unit 13, the test/start switch 17 and the current monitor 16. If no DC power is present at node J1, as detected by the input detection unit 13, depressing the test/start switch 17 momentarily causes the output controller 15 to enable the discharge controller 11 either for approximately one second or until a discharge current is detected by the current monitor 16. The power supply 1 is in a “test” mode. This allows the output controller 15 to test if an electronic device is connected by checking the output current. If no current is being drawn, which signifies that there is no load, the discharge of the cells 7 is halted. In this way, the bi-directional converter 30 is prevented from “running” when no DC power is present at node J1 and when no load is connected to the power supply 1.

Therefore, during a period of disuse or when not coupled to an electronic device, any discharge of the cells 7 is reduced. An example of an output controller 15 which performs the above tasks is a LP339 from National Semiconductor.

The discharge current is detected by the current monitor 16 and also the charge monitor 10 and the charge status or run-time of the cells 7 will be displayed via the charge indicator 5. Therefore, depressing the test/start switch 17 enables the charge indicator 5 which allows the user to check the run-time of the cells 7 without the need to connect the AC power adapter 12 or the electronic device.

The test/start switch 17 also serves a second purpose of manually starting the power supply 1. If the AC power adapter 12 is connected to supply DC power to node J1 or when the electronic device is connected to the power supply 1, depressing the test/start switch 17 starts the power supply 1. This activates the voltage converter 30 to either charge or discharge the cells 7 to power the electronic device. Similarly, the run-time of the cells 7 is displayed on the charge indicator 5. Depressing the test/start switch 17 again when the power supply 1 has started has no effect on the output controller 15.

The charge indicator 5 comprising the four LEDs 6 is coupled to the charge monitor 10 and provides an indication to the user of the charging/discharging status or run-time of the cells 7. The charge monitor 10 detects the current flow during the charging and discharging process and provides the run-time left in the cells 7. This information is displayed by the charge indicator 5 via the four LEDs 6. An example of a commercial available charge monitor is a BQ2063 from Texas Instrument.

The test/start switch 17 is connected in series with the LEDs 6 so that the current is not normally drawn from the cells 7 through the LEDs 6 during periods of disuse, which may otherwise drain the cells 7. The test/start switch 17 is also used to activate the discharge controller 11 to power the load, as described earlier. The power supply 1 may also include a sound generation device which is coupled to the charge monitor 10 to generate a sound when the charge level of the power supply 1 falls below a threshold level. This acts as a warning to the user of the low charge level.

FIG. 3 shows the use of the power supply 1 to power or charge a laptop computer 21. A connector 18 interfaces the output plug 4 to an input socket of the laptop computer 21. As different laptop models use different types of input sockets, changeable connectors 18 having different dimensions and polarity to fit the various input sockets may be provided. If a new laptop model is introduced which uses a different type of input socket, the user simply uses a corresponding connector 18 to use the power supply 1 with the new laptop model.

The output voltage Vo of the power supply 1 is adapted to match an input voltage of the laptop computer 21. As described, the means to vary the output voltage Vo may be via the switch 14 and adjusting the position of the switch 14 varies the output voltage Vo. The user thus selects the required output voltage Vo in accordance with the input voltage of the laptop computer 21 by adjusting the position of the switch 14. Typically, a laptop computer 21 accepts a DC input voltage and therefore, a range of DC voltages, for example 15V, 16V, 17V, 18V and 20V may be provided for selection by the user. The selection range may be factory preset or customised to each user's requirement. Typically, the selection range includes the input DC voltages of popular laptop computers 21 in the respective laptop markets.

An advantage of using changeable connectors 18 and a variable output voltage Vo which adapts to different laptop models 21 is that the power supply 1 is not restricted to a particular make or model of a laptop computer 21. This saves cost and adds to the flexibility of using the power supply 1 to power or charge different laptop computers 21 regardless of make or model.

The power supply 1 may further comprise a lock mechanism to lock the switch 14 to minimise accidental or unintentional adjustment. The mechanism may be such that adjustment of the switch 14 is only possible if the switch 14 is depressed at the same time the adjustment of the switch 14 is being carried out. Therefore, the risk of the power supply 1 providing an incorrect output voltage Vo to the laptop computer 21 is minimised.

The power supply 1 may be recharged using the AC power adapter 12. In this embodiment, the laptop computer's AC power adapter 12 is being used to convert an AC voltage from a mains power source to a DC voltage to charge the power supply 1. Therefore, an input connector 20 is provided to couple plug 19 of the adapter 12 to the input socket 2. The ability to use the AC power adapter 12 of the laptop computer 21 obviates the need for the user to carry another power adapter 12 and thus enhances mobility and reduces load. The connector 20 is also changeable to adapt to different plugs 19 of different power adapters 12. Alternatively, the power supply 1 may be equipped with its own AC power adapter 12 which omits the need for the input connector 20.

An advantage of such a configuration is that the power supply 1 can be separately charged without the need to connect to the laptop computer 21. Once the power supply 1 is fully charged, as indicated by the charge indicator 5, the user merely disconnects the power supply 1 from the mains power source and the power supply 1 is ready for use.

In addition to being an universal power supply which can adapt to different laptop computers 21, the power supply 1 also has an unique slim housing for ease of storage and transportation. The slim shape allows a mobile user to store the power supply 1 with ease similar to a magazine in the users carrier bag. In this embodiment, a rectangular shape is shown (in FIG. 1) but it will be apparent to a skilled reader in the art that other shapes may be used to facilitate ease of storage, portability or transportation of the power supply 1.

The power supply 1 may be used for two purposes either as a charger and/or power supply. When the battery pack in the laptop computer 21 is drained and requires recharging, the user may use the power supply 1 instead of searching for an AC mains power source. The user selects the desired output voltage Vo via the voltage adjustment switch 14 on the power supply 1 that corresponds to the input DC voltage of the laptop computer 21 and connects the connector 16 into the plug 4. Once done, the user may connect the power supply 1 into the input DC receptacle of the laptop computer 15.

An advantage of the power supply 1 is that there is no need for the user to power down the laptop 21 which otherwise the user may need to do to replace with another battery pack if there is only one battery bay in the laptop computer 21 and the user is away from an AC mains power source. In this way, the user can continue to work on the laptop computer 21 with minimum inconvenience or interruption. The power supply 1, in this mode, will function primarily as a charging means to charge the battery pack and at the same time power the laptop computer 21.

Alternatively, the user may choose to remove the battery pack or not use the battery pack from the outset and use the power supply 1 as the primary power supply for the laptop computer 21. In this way, the power supply 1 performs the function of supplying power to the laptop computer 21 rather than for charging purposes.

During use, the power supply 1 fits neatly underneath the laptop computer 21 and thus frees up working space. The surface of the power supply 1 may be made of micro-grooved polymer or polyethylene which eliminates slippage and thus provides better grip and support for the laptop computer 21. Alternatively, If an external mouse is used, the power supply 1 can be placed beside the laptop computer 21 and the surface of the power supply 1 used as a mouse pad. The material on the surface thus improves the grip and traction of the mouse ball even at fast mouse speeds.

The user monitors the progress of the charging or charge status of the cells via the voltage indicator 5. If the power supply 1 is used as a charger to charge the laptop's battery pack, the user can monitor the charging progress via the laptop's power management system. Once the battery pack of the laptop computer 21 is fully charged, the power supply 1 may be disconnected and the remaining charge can be used to charge or power another electronic device. Alternatively, the power supply 1 may remain connected and used to power the laptop computer 21.

1. A power supply comprising an electric cell arranged to generate an intermediate voltage, and voltage conversion means coupled to the electric cell, the voltage conversion means converting the intermediate voltage to an output voltage, wherein the conversion means comprises adjustment means to vary the output voltage.

2. A power supply according to claim 1, wherein the adjustment means comprises a manual switch.

3. A power supply according to claim 2, further comprising means to lock the switch.

4. A power supply according to claim 1, wherein the adjustment means comprises detection means to detect an input voltage of an electronic device coupled to the output voltage, in use.

5. A power supply comprising an electric cell arranged to generate an intermediate voltage, and voltage conversion means coupled to the electric cell, the voltage conversion means converting the intermediate voltage to an output voltage, wherein the conversion means comprises adjustment means to vary the output voltage, wherein the electric cell is rechargeable.

6. A power supply according to claim 5, further comprising charging means coupled to the electric cell to charge the electric cell.

7. A power supply according to claims 6, wherein the charging means is adapted to receive a plurality of input voltages.

8. A power supply according to claims 5, wherein the charging means further comprises means to monitor charging or charge status of the electric cell.

9. A power supply according to claim 8, further comprising a visual display device for displaying the charging or charge status of the electric cell.

10. A power supply according to claim 9, wherein the visual display device comprises a light emitting device.

11. A power supply according to claim 10, wherein the visual display device comprises a plurality of light emitting devices.

12. A power supply according to claim 9, wherein the visual display device comprises a graphic display.

13. A power supply according to claim 9, wherein the visual display device is activated by a switch.

14. A power supply according to claim 1, wherein the voltage conversion means is activated by a switch.

15. A power supply comprising an electric cell arranged to generate an intermediate voltage, and voltage conversion means coupled to the electric cell, the voltage conversion means converting the intermediate voltage to an output voltage, wherein the conversion means comprises adjustment means to vary the output voltage, further comprising a sound generation device which is activated when the electric cell is at a predetermined charge level.

16. A power supply according to claim 1, wherein the electric cell is a lithium-ion cell.

17. A power supply according to claim 1, further comprising a number of electric cells.

18. A power supply according to claim 1, further comprising a housing.

19. A power supply according to claim 18, wherein the housing has length, width and thickness, the thickness being shorter than either one of width and length.

20. A housing according to claim, where in the shape of the housing is rectangular.

21. A power supply according to claim 1, wherein the voltage conversion means is a DC-DC voltage converter.

22. A power supply according to claim 1, further comprising deactivation means to reduce discharging of the electric cell when not coupled to an electric device.
